(19) United States
(12) Patent Application Publication
(10) Pub. No.: US 2006/0239626 A1
(43) Pub. Date: Oct. 26, 2006

(54) Lossy clad light guide screen

(76) Inventors: Huei Pei Kuo, Palo Alto, CA (US); Lawrence M. Hubby JR., Palo Alto, CA (US); Steven L. Naberhuis, Palo Alto, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/111,013

(22) Filed: Apr. 21, 2005

(51) Int. Cl. G02B 6/08; G02B 6/06

(52) U.S. Cl. 385/120; 385/116

(57) ABSTRACT

Provided is a lossy clad light guide screen. A plurality of aligned light guides are provided. Each light guide has an input end, a midsection, an output end, a core and a circumferential lossy clad. The plurality of input ends are aligned and provide an input face. The plurality of output ends are aligned and provide a viewing surface. A related method of making a lossy clad light guide screen is also provided.

### RELATED APPLICATIONS

This application is related to commonly owned U.S. patent application Ser. No. 10/698,829, filed on Oct. 31, 2003 and entitled “Light Guide Apparatus For Use In Rear Projection Display Environments”, herein incorporated by reference.

### FIELD

This invention relates generally to the field of display devices, and more particularly to screens and related hardware employed in rear projection display devices.

### BACKGROUND

Socially and professionally, most people rely upon video displays in one form or another for at least a portion of their work and/or recreation. With a growing demand for large screens, such as high definition television (HDTV), cathode ray tubes (CRTs) have largely given way to displays composed of liquid crystal devices (LCDs), plasma display panels (PDPs), or front or rear projection systems.

A CRT operates by scanning electron beam(s) that excite phosphor materials on the back side of a transparent screen, wherein the intensity of each pixel is commonly tied to the intensity of the electron beam. With a PDP, each pixel is an individual light-emitting device capable of generating its own light. With an LCD, each pixel is a back-lit, light modulating liquid crystal device.

As neither system utilizes a large tube, LCD and PDP screens may be quite thin and often are lighter than comparable CRT displays. However, the manufacturing process for LCDs, PDPs and most other flat panel displays is much more complex and intensive with respect to both equipment and materials than that of CRTs, typically resulting in higher selling prices.

Projection systems offer alternatives to PDP and LCD based systems. In many cases, projection display systems are less expensive than comparably sized PDP or LCD display systems. Rear projection display systems typically employ a wide angle projection lens (or multiple lenses), operating in connection with one or more reflective surfaces to direct light received from the projector through the lens(es) to the back of a screen. The lens and mirror arrangement typically enlarges the image as well.

To accommodate the projector, one or more lenses, and reflectors, rear projection displays are typically 18 to 20 inches deep and not suitable for on-wall mounting. A typical rear projection system offering a 55-inch HDTV screen may weigh less than a comparable CRT, but at 200+ pounds it may be difficult and awkward to install and support.

Often, rear projection display devices exhibit average or below average picture quality in certain environments. For example, rear projection displays may be difficult to see when viewed from particular angles within a room setting or when light varies within the environment. Aside from a theatrical setting, light output and contrast is a constant issue in most settings and viewing environments.

Despite advancements in projectors and enhanced lens elements, the lens and reflector design remains generally unchanged and tends to be a limiting factor in both picture quality and overall display system thickness.

A display may also have to contend with two types of contrast—dark room contrast and light room contrast. Dark room contrast is simply the contrast between light and dark image objects in a dark environment such as a theater setting. Light room contrast is simply the contrast between light and dark image objects in a light environment. Front projection systems typically provide good dark room contrast where ambient light is minimized but, as they rely on a screen reflector, they are subject to poor light room contrast due to the interference of ambient light.

Rear projection displays, LEDs, LCDs and PDPs typically provide better light room contrast than front projection systems. However, ambient light striking the viewing surface can be an issue for viewers and buying consumers. Ambient light is oftentimes highly variable. For typical consumers, what makes a display attractive is often high contrast in a bright room.

A developing variation of rear projection displays utilizes light guides, such as optical fibers, to route an image from an input location to an output location and to magnify the image. Such displays may be referred to as light guide screens (LGS's).

Light room contrast and dark room contrast are generally issues that also apply to LGS systems. In addition, stray light within the LGS system can interfere with the intended image provided to the viewer. Stray internal light may originate from any number of different sources and may change over time.

More specifically, if stray light is introduced into one or more of the light guides, the resolution of the intended picture would be degraded. Further, if light bleeds from one light guide to another—a phenomena understood as cross-talk, the stray light may propagate through the LGS and emerge the output surface at locations unrelated to the input image, resulting in a reduced contrast.

The light guides, commonly glass or acrylic, are delicate and may be inadvertently damaged by any number of actions or events occurring in the environment where an LGS is employed. As each light guide is an integral component to the LGS, repair of one or more light guides may be financially impractical.

Weight, thickness, durability, cost, aesthetic appearance and quality are key considerations for rear projection display systems and display screens. From the manufacturing point of view, cost of production and increased yield are also important.

Hence, there is a need for a rear projection display that overcomes one or more of the drawbacks identified above.

### SUMMARY

This invention provides lossy clad light guide screen displays.

In particular, and by way of example only, according to an embodiment, provided is a lossy clad light guide screen, including: a plurality of aligned light guides, each light guide having an input end, a midsection, an output end, a core and a circumferential lossy clad; the plurality of input ends aligned, and the plurality of output ends aligned as a viewing surface.

### BRIEF DESCRIPTION OF THE DRAWINGS

FIG. 1 is a partial cross-sectional view of a lossy clad light guide according to an embodiment;

FIG. 2 is an enlarged cross-sectional view of a portion of the lossy clad light guide shown in FIG. 1;

FIG. 3 is a plane view of a light guide layer established with a plurality of lossy clad light guides as shown in FIG. 1;

FIG. 4 is an enlarged partial end view of the light guide layer shown in FIG. 3;

FIG. 5 is a schematic diagram of a lossy clad light guide screen as established with a plurality of light guide layer as shown in FIG. 3;

FIG. 6 is a schematic diagram of a lossy clad light guide screen and enclosing case according to an embodiment; and

FIG. 7 is a flowchart of a method of making a lossy clad light guide screen in accordance with an embodiment.

### DETAILED DESCRIPTION

Before proceeding with the detailed description, it is to be appreciated that the present teaching is by way of example, not by limitation. The concepts herein are not limited to use or application with a specific light guide screen. Thus, although the instrumentalities described herein are for the convenience of explanation, shown and described with respect to exemplary embodiments, it will be appreciated that the principles herein may be equally applied in other types of light guide screen display systems.

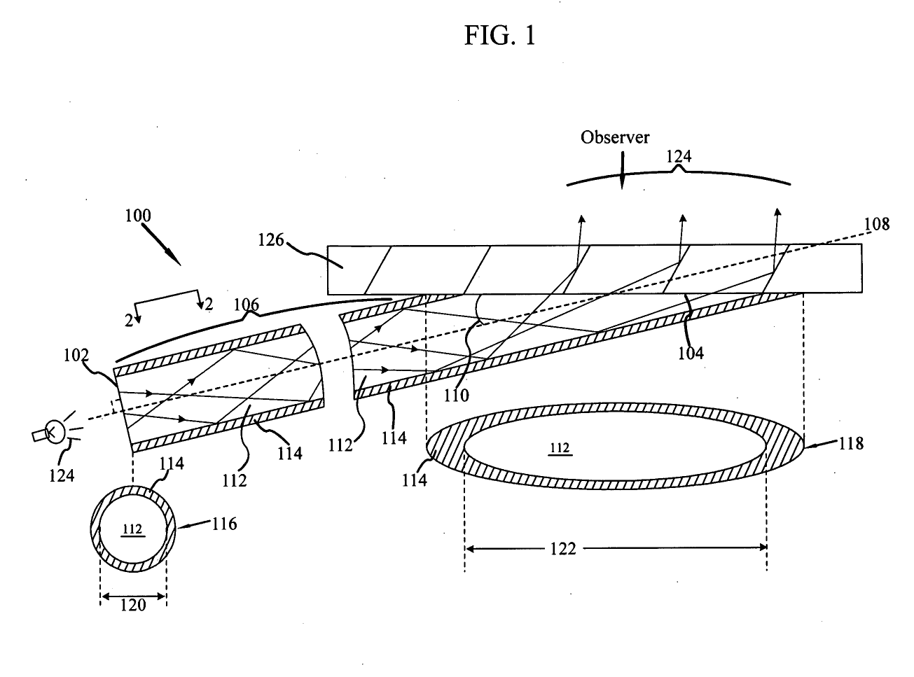

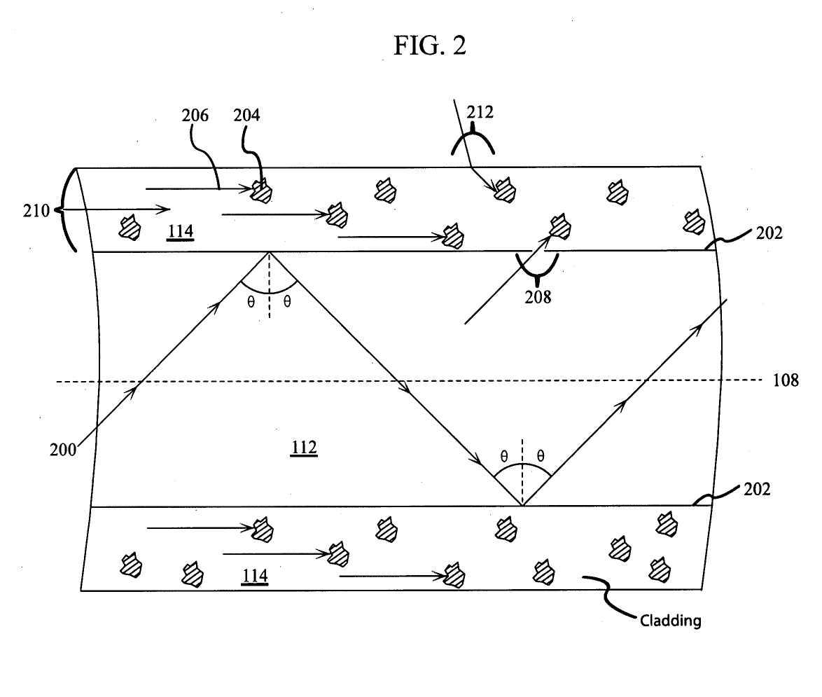

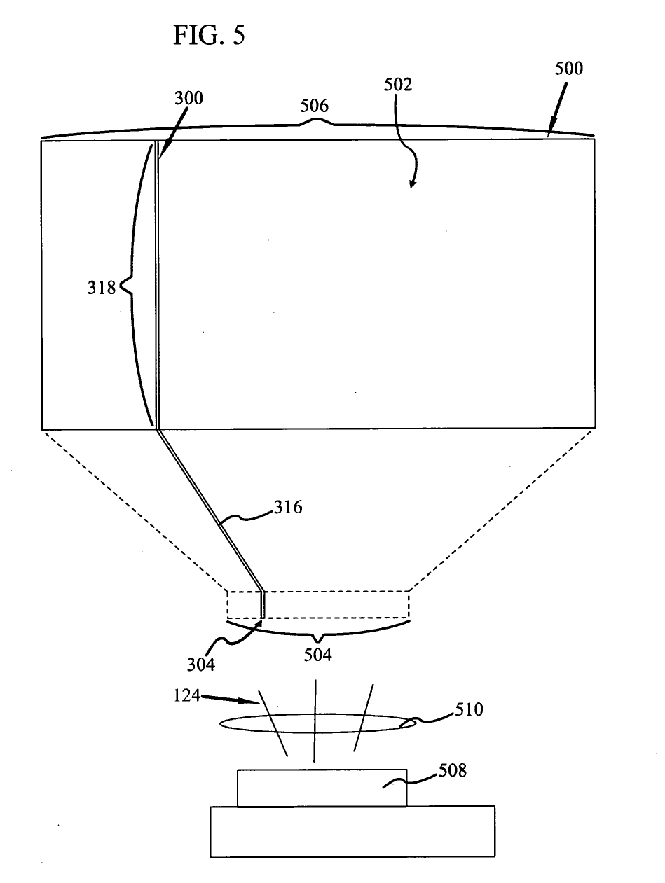

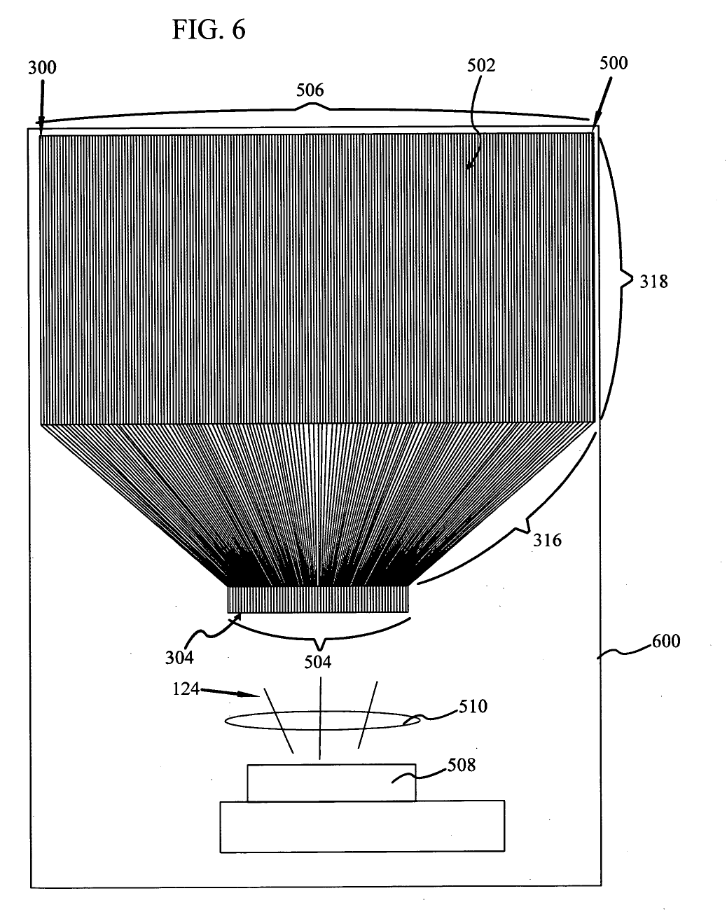

Referring now to the drawings, and more specifically to FIGS. 1 and 2, there is shown an enlarged cross-section of a single light guide 100 as used in a light guide screen, shown in FIGS. 5 and 6.

More specifically, FIG. 1 conceptually illustrates a cross-section of a single light guide 100, having an input end 102, an output end 104, and a midsection 106. In at least one embodiment, input end 102 is substantially perpendicular to longitudinal centerline 108. Further, in at least one embodiment, output end 104 is structured and arranged to be a magnifying output end. Such a magnification property is provided in at least one embodiment by configuring output end 104 at an acute angle 110 relative to the longitudinal centerline 108.

Light guide 100 has a longitudinal core 112 and a circumferential lossy clad 114. In at least one embodiment, it is realized that light guide 100 may bend, coil or otherwise contour such that longitudinal centerline 108 is not always a straight line. Light guide 100 is shown with core 112 symmetric about longitudinal centerline 108 for ease of discussion and illustration.

In the embodiment shown, input end 102 has a substantially circular cross-section 116, while the magnifying output end 104 has a substantially elliptical cross-section 118. The horizontal width 120 of input end 102 is not as great as the horizontal width 122 of the output end 104. In at least one alternative embodiment, light guide 100 may have cross-sections relating to a square, triangle, trapezoid, octagon or other polygon.

In at least one embodiment, the core 112 is formed of generally optically clear plastic or plastic-type material, including but not limited to plastic such as acrylic, Plexiglas, polystyrene, polycarbonate material and combinations thereof. In an alternative embodiment, the core 112 is formed of generally optically clear glass. The core 112 has an index of refraction, n1, and the lossy clad 114 has an index of refraction n2, wherein n1>n2. In at least one embodiment, each light guide 100 is an optical fiber with lossy clad.

Each light guide 100 is preferably substantially totally internally reflecting, such that light, illustrated as lines 124, received at the input end 102 is substantially delivered to the output end 104 with minimal loss. Lossy clad 114 is a material having a refraction index lower then that of core 112.

Total internal reflection, or TIR, is the reflection of all incident light off a boundary between lossy clad 114 and core 112. TIR occurs when a light ray is both in a medium of higher index of refraction and approaches a medium of lower index of refraction, and the angle of incidence for the light ray is greater than the “critical angle.”

The critical angle is defined as the smallest angle of incidence measured with respect to a line normal to the boundary between two optical media for which light is refracted at an exit angle of 90 degrees (that is, the light propagates along the boundary) when the light impinges on the boundary from the side of the higher index of refraction. For any angle of incidence greater than the critical angle, the light traveling through the medium with a higher index of refraction will undergo total internal reflection. The value of the critical angle depends upon the combination of materials present on each side of the boundary.

FIG. 2 is an enlarged portion of light guide 100 provided to further illustrate the possible TIR propagation of light ray 200. FIG. 2 also illustrates advantageous properties of the lossy clad 114. In at least one embodiment, lossy clad 114 is in intimate contact with core 112, and as such boundary 202 is established.

Light ray 200 travels in light guide 100 through successive TIR, as shown. The angle of incidence and reflection off boundary 202 remains unchanged at angle θ until such time as light ray 200 is delivered to the output end, not shown in FIG. 2.

Lossy clad 114 includes material 204 that is light absorbing. For ease of discussion and illustration, material 204 is shown as separate deposits dispersed within the lossy clad layer. However, it is understood and appreciated that in at least one embodiment, lossy clad 114 is formed from material 204.

Light 206 that is introduced to lossy clad 114 such that it attempts to travel within lossy clad 114 is absorbed upon encountering material 204. Light 206 may be introduced from a variety of different sources, such as, but not limited to, a defect 208 in the boundary 202, incidence upon an exposed end 210 of the lossy clad 114, stray external light 212 incident upon the lossy clad 114, and or combinations thereof. If light guide 100 is bent sharply, the incident angle of light ray 200 upon the boundary 202 may be such that a portion of light ray 200 does not experience TIR and enters the lossy clad 114.

In at least one embodiment, lossy clad 114 includes particles of a transition metal as material 204. More specifically, in at least one embodiment lossy clad 114 includes a composition containing titanium oxide, although other compounds containing transition metals (e.g., oxides of iron, nickel, copper, cobalt, zinc, etc.) may be used to achieve the desired light absorbing characteristic of lossy clad 114. Other light absorbing materials such as urethane acrylate or carbon (graphite), for example, may also be employed as material 204.

With respect to light, absorption refers to the absorption of photons by a material. Absorption is measured as the ratio of transmitted light intensity (Iₜ) to incident intensity (I₀). The expression relating absorption to the extinction coefficient, a material characteristic, is as follows:
ln(Iₜ/I₀)=−2πk/λ
where k is the extinction coefficient and λ is the wavelength of light.

Transition metals, and specifically their oxides, are particularly effective in absorbing light, as the electron states of such materials readily absorb photons in a relatively short distance. When a photon is absorbed by the atoms of the material, the atoms gain the energy of the photons. Specifically, an atom's electrons may jump to a higher energy level. This absorbed energy may be given off as heat; however, in the embodiments described, the effect of this heat upon the overall light guide screen is substantially negligible.

Although lossy clad 114 provides an advantageous property of light absorption for light within or entering lossy clad 114, the light absorption property of material 204 does not significantly alter the TIR properties established at boundary 202 between core 112 and lossy clad 114. Absorption of light from the core 112 by the lossy clad 114 during TIR is of little consequence and effectively negligible given the length of the light guides as used in the LGS 500 (see FIG. 5). It is to be understood and appreciated that lossy clad 114 need not be a substantially black material or even an opaque material.

Returning to FIG. 2, with a typical light guide 100 such as an optical fiber, for example, the spread of light to either side of longitudinal centerline 108 is typically about thirty degrees (30°). Although the angle of output end 104 may provide a flat surface perpendicular to the line of sight of an observer, exiting light will continue substantially in the direction last suggested by longitudinal centerline 108 unless reflected or refracted at output end 104.

In at least one embodiment where such redirection is desired, such redirection of light is accomplished with a light redirection layer. In at least one embodiment the light redirection layer is a louver layer 126 (also show in FIG. 1). A method for making a louver layer 126 is described in patent application Ser. No. 11/052,612, filed Feb. 7, 2005, entitled “Method of Making A Louver Device for A Light Guide Screen”, which is herein incorporated by reference. Various types of louver layers 120 are described in patent application Ser. No. 11/052,605, filed Feb. 7, 2005, entitled “Holographic Louver Device for A Light Guide Screen,” which is herein incorporated by reference.

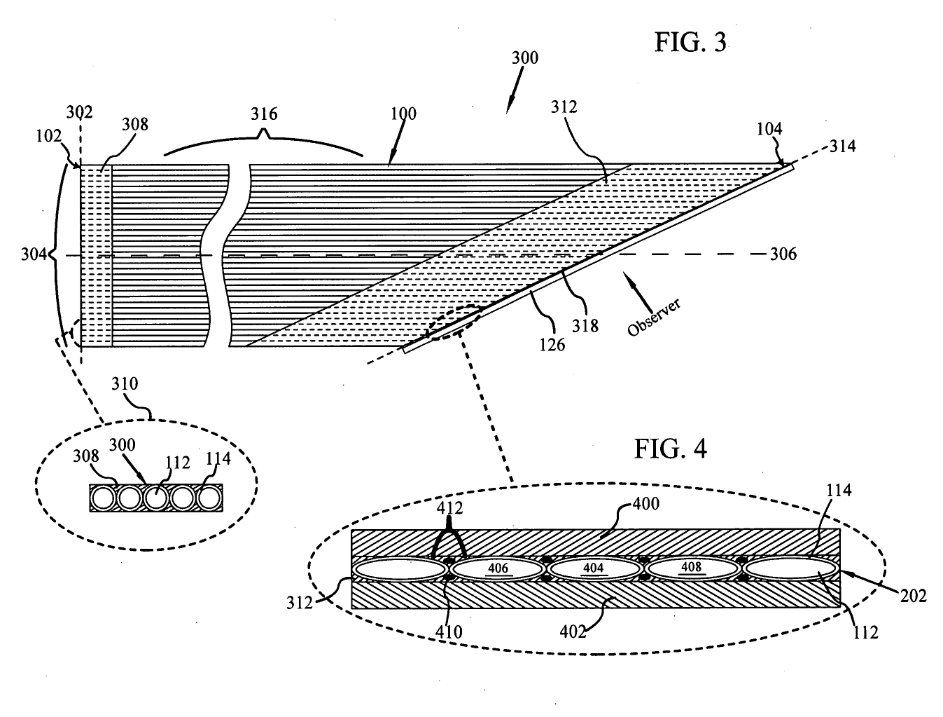

FIG. 3 illustrates a light guide layer 300, established with a plurality of light guides 100. In at least one embodiment, light guide layer 300 is a structured and arranged as a magnifying light guide layer 300. A plurality of these light guide layer 300 provide a light guide screen display 500, as shown in FIGS. 5 and 6. With respect to FIG. 3, for each light guide layer 300, the plurality of input ends 102 are aligned and, in at least one embodiment, define a portion of dotted line 302.

It is this portion of line 302 that serves as the input location 304 of each light guide layer 300. In addition, in at least one embodiment, this portion of line 302 is substantially perpendicular to a longitudinal centerline 306. When the light guide layer 300 are stacked, the aligned input ends 102 provide an input face 504 (see FIGS. 5 and 6.). Bonding material 308 (e.g., glue) bonds the aligned input ends 102, as may be more fully appreciated in the enlarged partial end view bounded by dotted line 310.

In at least one embodiment, the plurality of output ends 104 within a given light guide layer 300 are aligned in substantially contiguous parallel contact, without intervening spacers or material separating each individual output end 104 from its neighbors on either side. In other words, the output ends 104 lie next to one another and are in actual contact, touching along their outer surfaces at one or more points. More specifically, the lossy clad 114 of one light guide 100 is in physical contact with the lossy clad 114 of at least one other light guide 100.

It is understood and appreciated that the cores 112 of each light guide 100 are not in contact; rather, the outer surface of the lossy clad 114 about the circumference of cores 112 is in contact. Moreover, over the course of each entire length, the core 112 of one light guide 100 will not contact the core 112 of another light guide 100.

FIG. 3 illustratively shows thirty-three light guides 100 for ease of discussion and conceptualization. Embodiments may employ more or fewer light guides 100. In at least one embodiment, light guides 100 are always in substantially contiguous parallel contact, particularly at the aligned input ends 102 providing the input location defined by dotted line 302, and at the aligned output ends 104, providing an output location 318. Due to limitations in manufacturing, instances may arise where a small amount of space might exist between one or more light guides 100. However, the majority of light guides 100 are intended to be in substantially contiguous parallel contact. The midsections 106 of each light guide 100 may not necessarily be in contiguous contact.

In at least one embodiment, the midsections 106 of each light guide 100 are flexible. As such, it is understood and appreciated that a midsection 316 of light guide layer 300 may bend and twist such that longitudinal centerline 306 is not always a straight line; however, light guide layer 300 has been illustrated as substantially flat and straight for ease of discussion.

In at least one embodiment, bonding material 312 (e.g., glue) is disposed adjacent to output ends 104 bonding output ends 104 into a uniform line defining a portion of dashed line 314. Bonding material 312 may be substantially the same as bonding material 308.

In contrast to the input ends 102 defining a portion of line 302, the portion of line 314 defined by output ends 104 is usually not perpendicular to longitudinal centerline 306. More specifically, the dotted line 314 as defined by output ends 104 is angled relative to longitudinal centerline 306. A portion of line 314 defines the output location 318 for light guide layer 300. Moreover, each light guide layer 300 provides an input location 304, an output location 318 and a midsection 316.

FIG. 4 illustrates a partial enlarged end view of five output ends 104, shown in FIG. 3. As illustrated, in at least one embodiment, a top spacer 400 and a bottom spacer 402 are bonded to light guides 100 proximate to the output ends 104 shown in FIG. 3. The substantially contiguous parallel contact between the output ends 104 of light guides 100 may also be more fully appreciated. As shown, light guide 404 is in intimate contact with light guide 406, lying to the left, and light guide 408, lying to the right. The location of bonding material 312 disposed adjacent to the light guides 100 may also be more fully appreciated

With respect to FIGS. 3 and 4, additional advantageous properties of the lossy clad 114 may also be appreciated. As lossy clad 114 absorbs light, the lossy clad 114 reduces cross talk between light guide cores 112. More specifically, should one or more light guide cores 112 leak light for any of a variety of potential reasons (e.g. defect in boundary between core 112 and lossy clad 114, breakage, sharp bend, damage, etc.), the light will be attenuated by the lossy clad 114. Wayward light that propagates to the lossy clad 114 and that is not entirely absorbed by one lossy clad 114 may propagate to, and be absorbed by, another lossy clad 114. Stated another way, lossy clad 114 reduces the propagation of light from one light guide core 112 to another light guide core 112.

In at least one embodiment, the bonding materials 308 and 312 are selected with an index of refraction substantially identical to the index of refraction selected for the lossy clad 114, n2 as described above. A boundaryless union therefore exists between lossy clad 114 and bonding materials 308 and 312.

To further eliminate the propagation of unintended light, in at least one embodiment, Extramural Absorption material, or more commonly EMA material 410, is disposed about at least a portion of the light guides 100, such as, for example in interstitial spaces 412. EMA material 410 is specifically engineered to absorb photons and, in at least one embodiment, may be the same material as the lossy clad 114 and/or the bonding materials 308 and 312. In at least one embodiment, the EMA bonding material is a silicon material incorporating titanium particles.

In a typical display screen, images are represented by a plurality of individual areas of varying brightness and/or color, commonly referred to as pixels. The brightness and color of each pixel may be the same or different as its neighbor pixels. As a whole, the patterns established by the varying brightness and color of the pixels are perceived by observers as shapes, pictures and images.

Typically the displays are designed such that when viewed at the intended range of distance between the observer and the display, the descrete nature of each pixel is not observed or perceived by the unaided eye. A typical standard TV display provides a horizontal-to-vertical resolution of 640:480 with about 307,200 pixels. A typical HDTV screen provides a horizontal-to-vertical resolution of 1920:1080 with about 2,116,800 pixels—a more than six-fold increase in pixels over a traditional TV display.

With respect to a light guide display, in at least one embodiment, each display pixel is provided by at least one output end 104 of each light guide 100. In the same at least one embodiment, the pixel size on the output surface is ˜0.7 mm for a 60-inch diagonal HDTV screen. When viewed at a distance of >2.5 meters, human eyes cannot resolve the individual pixels.

FIG. 5 illustrates a portion of a lossy-clad light-guide screen (LGS) display 500. In at least one embodiment, lossy-clad LGS 500 is provided by a plurality of lossy-clad light guides 100 organized into a plurality of stacked light guide layers 300. More specifically, LGS 500 has a plurality of aligned magnifying light guide layers 300 (described above), providing a viewing surface 502. Each light guide layer 300 provides an input location 304, a midsection 316 and an output location 318. Whereas FIG. 5 illustrates a single light guide layer 300 for ease of discussion and illustration to identify the elements, FIG. 6 may be referred to as a more complete rendering of the lossy clad LGS 500 with a plurality of light guide layers 300.

Collectively, the aligned input ends of each light guide layer 300 provide input face 504. Similarly, collectively, output ends 104 of each light guide layer 300 provide output face 506. An image is projected upon input face 504. Such an image may be provided in at least one embodiment by an image source 508, proximate to input face 504. A lens 510 may optically couple the at least one image source 508 to the input face 504, or the lens 510 may be an integral part of image source 508.

Image source 508 may be any device capable of providing a visual image, such as, for example, a projector. Image source 508 is not limited simply to this example, and may also include combinations of devices. For example, multiple light/image sources (such as red, green and blue illuminated liquid crystal light vales) may be used as well.

It is appreciated that input face 504 exposes the plurality of cores 112 as well as portions of the lossy clad 114 to image source 508. Whereas the cores 112 receive light 124, and through TIR, propagate the received light to the output face 506, some portion of light 124 may be incident upon the lossy clad 114. The light absorption properties of the lossy clad 114 advantageously reduces the amount of reflected light, and insure that the percentage of light 124 not received by the cores 112 does not result in distortion/degradation of the intended image as provided to the output face 508.

As is shown in FIG. 5, in at least one embodiment, each light guide layer 300 is a continuous vertical slice across the viewing surface 502 of LGS 500. In an alternative configuration (not shown), each light guide layer 300 is a continuous horizontal slice across the viewing surface 502 of LGS 500.

The midsections of the light guide layers 300 permit input face 504 to be oriented differently from viewing surface 502. In at least one embodiment, such separate alignment is advantageous in permitting a large HDTV display, such as a fifty-inch display, to have a thickness of about four inches. Depending on the cross-sectional dimensions of the light guides 100 and the resolution of the screen, LGS 500 could be thinner or thicker than four inches. Reasonable thicknesses between one and six inches could be realized for television displays.

By enclosing the lossy clad LGS 500, at least one image source 508 and at least one lens 510 (if separate from image source 508) within a case 600 as shown in FIG. 6, a low cost, high quality, high resolution HDTV display may be provided. The lossy clad 114 as described above with respect to FIGS. 1 and 2 provides the lossy clad LGS 500 with advantageously improved contrast characteristics. More specifically, as well as absorbing wayward internal light, the lossy clad 114 may absorb light incident upon the viewing surface 502, thereby further improving the contrast of the displayed image.

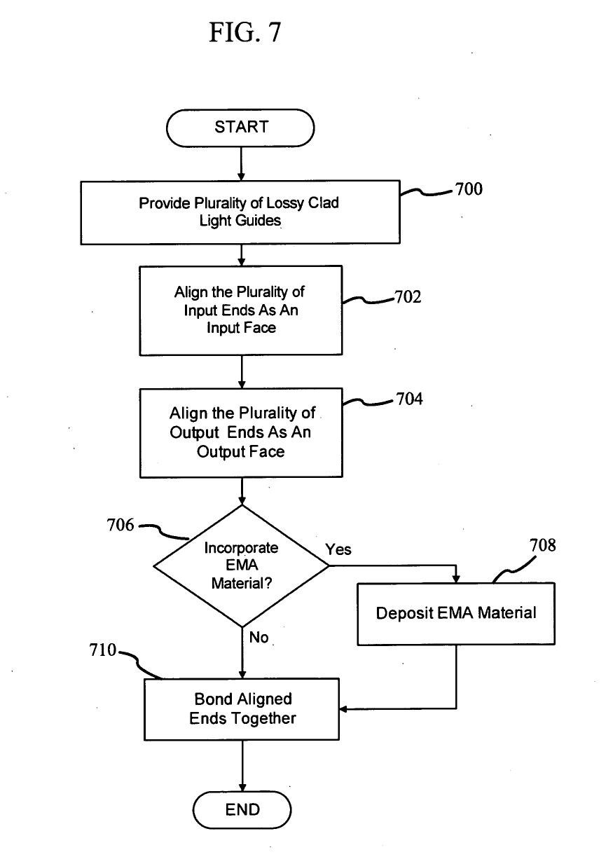

Having discussed the above physical embodiments of a lossy clad LGS 500, another embodiment relating to the method of making a lossy clad LGS 500 will now be summarized with reference to the flowchart of FIG. 7. It will be appreciated that the described method need not be performed in the order in which it is herein described, but that this description is merely exemplary of at least one method of making a lossy clad LGS 500.

As indicated in block 700, the fabrication process commences by providing a plurality of lossy clad light guides such as light guides 100 shown and described above with respect to FIGS. 1 and 2. Briefly restated, each light guide 100 has an input end 102, a midsection 106, an output end 104, a core 112 and a circumferential lossy clad 114 (see FIGS. 1 and 2).

More specifically, in at least one embodiment, the light guides 100 are arranged into a plurality of light guide layers 300, each light guide layer 300 one light guide thick. Further, as shown and described above with respect to FIGS. 3 and 4, the output ends 104 of the light guides 100 in each layer are in substantially contiguous parallel contact.

The plurality of input ends are aligned as an input face, block 702. The plurality of output ends are aligned as an output face, block 704. If EMA material 410 is to be incorporated, decision 706, EMA material 410 is appropriately deposited, block 708, such as at least one EMA material 410 in the interstitial spaces 412 adjacent to the point of contact between two light guides 100, see FIG. 400.

The aligned input ends are bonded together and the aligned output ends are bonded together, block 710. EMA material 410 may be provided as part of the bonding material used to bond the aligned input ends and output ends. In at least one embodiment, the bonding material is selected to have an index of refraction matched to the index of refraction of the lossy clad.

Changes may be made in the above methods, systems and structures without departing from the scope thereof. It should thus be noted that the matter contained in the above description and/or shown in the accompanying drawings should be interpreted as illustrative and not in a limiting sense. The following claims are intended to cover all generic and specific features described herein, as well as all statements of the scope of the present method, system and structure, which, as a matter of language, might be said to fall therebetween.

What is claimed is:

1. A lossy clad light guide screen, comprising:
a plurality of aligned light guides, each light guide having an input end, a midsection, an output end, a core and a circumferential lossy clad;
the plurality of input ends aligned; and
the plurality of output ends aligned as a viewing surface.

2. The lossy clad light guide screen of claim 1, wherein the lossy clad is in intimate contact with the core of each light guide.

3. The lossy clad light guide screen of claim 1, the aligned output ends being in substantially contiguous parallel contact for at least one cross section of the viewing surface.

4. The lossy clad light guide screen of claim 1, wherein the lossy clad absorbs light propagating in the lossy clad.

5. A lossy clad light guide screen, comprising:
a plurality of aligned light guide layers providing a viewing surface, each light guide layer including:
a plurality of light guides, each light guide having an input end, a midsection, an output end, a core and a circumferential lossy clad;
the plurality of input ends aligned; and
the plurality of output ends aligned.

6. The lossy clad light guide screen of claim 5, wherein the lossy clad incorporates transition metal particles.

7. The lossy clad light guide screen of claim 5, wherein the lossy clad incorporates titanium oxide particles.

8. The lossy clad light guide screen of claim 5, wherein the lossy clad incorporates carbon particles.

9. The lossy clad light guide screen of claim 5, wherein the lossy clad is in intimate contact with the core of each light guide.

10. The lossy clad light guide screen of claim 5, wherein the lossy clad reduces cross talk between light guide cores.

11. The lossy clad light guide screen of claim 5, wherein the lossy clad absorbs light propagating in the lossy clad.

12. The lossy clad light guide screen of claim 5, wherein the output ends within each light guide layer are in substantially contiguous parallel contact.

13. The lossy clad light guide screen of claim 5, further including an extramural absorption material disposed adjacent to at least a portion of the light guides.

14. The lossy clad light guide screen of claim 13, wherein the lossy clad has a selected index of refraction, the extramural absorption material having an index of refraction matched to the lossy clad.

15. The lossy clad light guide screen of claim 13, wherein the extramural absorption material is embodied in glue bonding the plurality of aligned output ends together.

16. The lossy clad light guide screen of claim 13, wherein the extramural absorption material is embodied in glue bonding the plurality of aligned input ends together.

17. A method of making a lossy clad light guide screen, comprising:
providing a plurality of light guides, each having an input end, a midsection, an output end, a core and a circumferential lossy clad;
aligning the plurality of output ends as an output surface; and
aligning the plurality of input ends as an input surface.

18. The method of claim 17, further including bonding at least the aligned input ends together with a bonding material.

19. The method of claim 18, wherein the bonding material includes extramural absorption material.

20. The method of claim 17, further including depositing extramural absorption material adjacent to at least a portion of the light guides.

21. The method of claim 17, wherein the lossy clad has a selected index of refraction and the bonding material has a matching index of refraction.

22. The method of claim 17, wherein the plurality of light guides are arranged into a plurality of light guide layers, each layer one light guide thick, the output ends of each layer aligned in substantially contiguous parallel contact.

23. A lossy clad light guide screen, comprising:
a case;
a plurality of aligned light guide layers disposed within case and providing a viewing surface, each light guide layer including:
a plurality of light guides, each light guide having an input end, a midsection, an output end, a core and a circumferential lossy clad;
the plurality of input ends aligned;
the plurality of output ends aligned in substantially contiguous parallel contact;
the plurality of aligned output ends proving an output face;
the plurality of aligned input ends providing an input face; and
at least one image source disposed within the case proximate to the input face.

24. The lossy clad light guide screen of claim 23, wherein the lossy clad comprises a transition metal.

25. The lossy clad light guide screen of claim 23, wherein the lossy clad is in intimate contact with the core of each light guide.

26. The lossy clad light guide screen of claim 23, wherein the lossy clad absorbs light propagating in the lossy clad.
